(19) United States
(12) Patent Application Publication
(10) Pub. No.: US 2022/0274445 A1
(43) Pub. Date: Sep. 1, 2022

(54) PNEUMATIC TIRE

(71) Applicant: The Yokohama Rubber Co., LTD., Tokyo (JP)

(72) Inventors: Takamitsu CHAYA, Kanagawa (JP); Shinya HARIKAE, Kanagawa (JP)

(21) Appl. No.: 17/753,200

(22) PCT Filed: Aug. 25, 2020
(86) PCT No.: PCT/JP2020/032041

§ 371 Date: Feb. 23, 2022

(30) Foreign Application Priority Data
Aug. 29, 2019 (JP) 2019-157017

(51) Int. Cl. B60C 9/08; B60C 17/00; B60C 9/00; D02G 3/48

(52) U.S. Cl. CPC B60C 9/08; B60C 17/0009; B60C 9/0042; D02G 3/48; B60C 2009/0078; B60C 2009/0092; B60C 2009/045

(57) ABSTRACT

In a pneumatic tire in which a side reinforcing layer having a crescent-shaped cross-section is provided on an inner side in a tire width direction of a carcass layer in a sidewall portion, organic fiber cords having an elongation of 4.3% to 6.0% under a 1.5 cN/dtex load and a total fineness of 4000 dtex to 6000 dtex are used as carcass cords constituting the carcass layer.

### TECHNICAL FIELD

The present technology relates to a pneumatic tire provided with a side reinforcing layer having a cross sectional shape that is a crescent-shape, on an inner side of a sidewall portion to enable run-flat traveling.

### BACKGROUND ART

As a pneumatic tire (so-called run-flat tire) that can run safely a certain distance even when punctured, a pneumatic tire provided with a side reinforcing layer having a cross-sectional shape that is crescent-shape and formed of hard rubber on an inner side of a sidewall portion has been proposed (for example, see Japan Unexamined Patent Publication No. 2014-088502). Since the side reinforcing layer supports a load of a vehicle in the case of puncture, such a tire can run in a punctured state (run-flat traveling).

On the other hand, since the run-flat tire is provided with the side reinforcing layer, the rigidity of the sidewall portion tends to be increased compared with an ordinary tire without a side reinforcing layer. Consequently, the run-flat tire may have difficulty in maintaining ride comfort under normal travel conditions equivalently to the ordinary tire. As a result, for example, by using organic fiber cords having low rigidity as carcass cords constituting a carcass layer, it is conceivable to decrease the rigidity of the sidewall portion and improve the ride comfort of the run-flat tire. However, the decrease in rigidity of the sidewall portion may cause a deterioration in steering stability, and measures for maintaining ride comfort and steering stability of the run-flat tire in a well-balanced manner are required.

### SUMMARY

An object of the present technology is to provide a pneumatic tire that can provide ride comfort and steering stability under normal travel conditions in a well-balanced and highly compatible manner while ensuring run-flat durability.

A pneumatic tire according to an embodiment of the present technology includes: a tread portion extending in a tire circumferential direction and having an annular shape; a pair of sidewall portions respectively disposed on both sides of the tread portion; a pair of bead portions each disposed on an inner side of the sidewall portion in a tire radial direction; a carcass layer mounted between the pair of bead portions; and side reinforcing layers each provided on an inner side in a tire width direction of the carcass layer in the sidewall portion and having a crescent-shaped cross-section. Carcass cords that constitute the carcass layer have an elongation of 4.3% to 6.0% under a 1.5 cN/dtex load. The carcass cords are organic fiber cords having a total fineness of 4000 dtex to 6000 dtex.

In the present technology, by the side reinforcing layer provided on the inner side of the sidewall portion, run-flat durability is ensured, while ride comfort and steering stability under normal travel conditions can be provided in a well-balanced and highly compatible manner by the organic fiber cords (carcass cords) having physical properties described above. In particular, the elongation of the organic fiber cords under a 1.5 cN/dtex load is within the range described above, and thus it is conceivable to decrease rigidity of the sidewall portion and improve ride comfort under normal travel conditions. On the other hand, the total fineness of the organic fiber cords is within the range described above, and thus steering stability under normal travel conditions can be favorably maintained. Furthermore, the organic fiber cords have low rigidity and high fineness, and thus the effect of improving shock burst resistance can also be added (durability against damage (shock burst) in which the carcass breaks due to a large shock applied to the tire during traveling).

According to an embodiment of the present technology, a thermal shrinkage rate of the organic fiber cords is preferably 0.5% to 2.5%. As a result, the occurrence of kinking (twisting, folding, wrinkling, and collapsing in shape, and the like) in the organic fiber cords during vulcanization or deterioration in uniformity can be suppressed.

According to an embodiment of the present technology, a twist coefficient K expressed in the following formula (1) of the organic fiber cords is preferably 2000 to 2500. This mitigates cord fatigue, and thus excellent durability can be ensured.

K=T×D^{1/2} (1)

(where T is an upper number of twists (twists/10 cm) of the organic fiber cords, and D is a total fineness (dtex) of the organic fiber cords).

According to an embodiment of the present technology, an elongation at break of the organic fiber cords is preferably 20% or more. As a result, the effect of improving shock burst resistance due to the low rigidity and high fineness of the organic fiber cords can be further enhanced. In particular, run-flat tires include side reinforcing layers and thus are less likely to be deflected, and tend to have difficulty in easily obtaining good results by a plunger energy test known as an indicator of shock burst resistance. However, organic fiber cords having such an elongation at break are used, which sufficiently allows for deformation during the plunger energy test (when pressed against a plunger). Consequently, breaking energy (breaking durability of the tread portion against a projection input) can be improved, and shock burst resistance can be improved.

According to an embodiment of the present technology, the organic fiber cords are preferably formed of polyethylene terephthalate fibers. By using polyethylene terephthalate fibers (PET fibers) as just described, ride comfort and steering stability under normal travel conditions are advantageously provided by the excellent properties in a well-balanced and highly compatible manner. Furthermore, cost reduction and workability can be improved.

### BRIEF DESCRIPTION OF DRAWINGS

FIG. 1 is a meridian cross-sectional view illustrating a pneumatic tire according to an embodiment of the present technology.

### DETAILED DESCRIPTION

Configurations of embodiments of the present technology will be described in detail below with reference to the accompanying drawings.

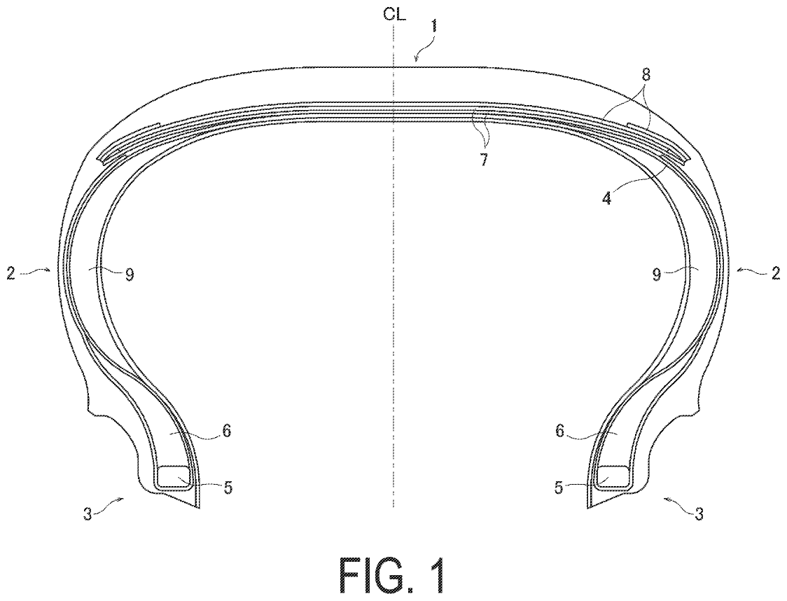

As illustrated in FIG. 1, a pneumatic tire of an embodiment of the present technology includes a tread portion 1, a pair of sidewall portions 2 disposed on both sides of the tread portion 1, and a pair of bead portions 3 disposed in the sidewall portions 2 at an inner side in a tire radial direction. Note that “CL” in FIG. 1 denotes a tire equator. Although not illustrated in FIG. 1 as FIG. 1 is a meridian cross-sectional view, the tread portion 1, the sidewall portions 2, and the bead portions 3 each extend in a tire circumferential direction to form an annular shape. Thus, a toroidal basic structure of the pneumatic tire is configured. Although the description using FIG. 1 is basically based on the illustrated meridian cross-sectional shape, all of the tire components each extend in the tire circumferential direction and form the annular shape.

A carcass layer 4 including a plurality of reinforcing cords (carcass cords described below) extending in the tire radial direction are mounted between the pair of left and right bead portions 3. A bead core 5 is embedded within each of the bead portions, and a bead filler 6 having an approximately triangular cross-sectional shape is disposed on an outer periphery of the bead core 5. The carcass layer 4 is folded back around the bead core 5 from an inner side to an outer side in the tire width direction. Accordingly, the bead core 5 and the bead filler 6 are wrapped by a body portion (a portion extending from the tread portion 1 through each of the sidewall portions 2 to each of the bead portions 3) and a folded back portion (a portion folded back around the bead core 5 of each bead portion 3 to extend toward each sidewall portion 2) of the carcass layer 4.

A plurality (in the illustrated example, two layers) of belt layers 7 are embedded on an outer circumferential side of the carcass layer 4 in the tread portion 1. Each of the belt layers 7 includes a plurality of reinforcing cords (belt cords) inclining with respect to the tire circumferential direction, with the belt cords of the layers intersecting each other. In the belt layers 7, an inclination angle of the belt cord with respect to the tire circumferential direction is set within a range of, for example, from 10° to 40°. For example, steel cords are preferably used as the belt cords.

In addition, a belt reinforcing layer 8 is provided on an outer circumferential side of the belt layers 7 for the purpose of improvement of high-speed durability and reduction of road noise. The belt reinforcing layer 8 includes a reinforcing cord (belt reinforcing cord) oriented in the tire circumferential direction. In the belt reinforcing layer 8, an angle of the belt reinforcing cord with respect to the tire circumferential direction is set within, for example, from 0° to 5°. As the belt reinforcing layer 8, a full cover layer that covers the entire region of the belt layer 7 in the width direction, a pair of edge cover layers that locally cover both end portions of the belt layer 7 in the tire width direction, or a combination thereof can be provided. For example, an organic fiber cord is preferably used as the belt reinforcing cord. The belt reinforcing layer 8 can be configured by helically winding a strip material made of at least a single organic fiber cord bunched and covered with coating rubber, for example, in the tire circumferential direction.

A side reinforcing layer 9 formed having a crescent-shaped cross-section is disposed on an inner side in the tire width direction of the carcass layer 4 in the sidewall portion 2. The side reinforcing layer 9 is formed of rubber (hard rubber) harder than other rubbers constituting the sidewall portion 2. Specifically, the hard rubber constituting the side reinforcing layer 9 has a JIS-A hardness of, for example, 70 to 80 and a modulus of, for example, 9.0 MPa to 10.0 MPa at 100% elongation. The side reinforcing layer 9 made of the hard rubber having such physical properties supports a load based on the rigidity thereof at the time of puncture and allows for running in a punctured state (run-flat traveling).

According to an embodiment of the present technology, in the pneumatic tire (run-flat tire) provided with the side reinforcing layer 9, specific cords are applied to the carcass cords constituting the carcass layer 4 described above. As a result, the basic structure of the entire tire is not limited to that described above as long as the tire is a run-flat tire provided with the side reinforcing layer 9.

According to an embodiment of the present technology, the carcass cords constituting the carcass layer 4 are formed of organic fiber cords obtained by intertwining organic fiber filament bundles. The elongation of the carcass cords (organic fiber cords) under a 1.5 cN/dtex load is from 4.3% to 6.0% and is preferably from 4.6% to 5.7%. Further, the total fineness of the organic fiber cords is from 4000 dtex to 6000 dtex and is preferably from 4400 dtex to 5600 dtex. Note that “elongation under a 1.5 cN/dtex load” is an elongation ratio (%) of sample cords measured under a 1.5 cN/dtex load by conducting a tensile test in accordance with JIS (Japanese Industrial Standard) L1017 “Test methods for chemical fiber tire cords” with a length of specimen between grips being 250 mm and a tensile speed being 300±20 mm/minute. Furthermore, the total fineness is not the sum of values actually measured for each cord, but is the sum of numerical values referred to as the given size or nominal fineness of each code.

According to an embodiment of the present technology, in ensuring run-flat durability with the side reinforcing layer provided on an inner side of the sidewall portion, organic fiber cords (carcass cords) having the physical properties described above are used as the carcass layer 4, and thus ride comfort and steering stability under normal travel conditions can be provided in a well-balanced and highly compatible manner. In particular, the elongation of the organic fiber cords under a 1.5 cN/dtex load is within the range described above, and thus the rigidity of the sidewall portion can be reduced and ride comfort under normal travel conditions can be improved. Meanwhile, the total fineness of the organic fiber cords is within the range described above, and thus steering stability under normal travel conditions can be favorably maintained. Furthermore, since the carcass cords (organic fiber cords) have low rigidity and high fineness, the effect of improving shock burst resistance can also be obtained.

In this case, when the elongation of the carcass cords (organic fiber cords) under a 1.5 cN/dtex load is less than 4.3%, rigidity cannot be sufficiently reduced, and thus ride comfort cannot be sufficiently ensured. When the elongation of the carcass cords under a 1.5 cN/dtex load exceeds 6.0%, rigidity is excessively decreased, and thus steering stability cannot be sufficiently ensured. When the total fineness of the carcass cords is less than 4000 dtex, the high fineness of the carcass cords is not sufficiently expected, and thus steering stability cannot be sufficiently ensured. When the total fineness of the carcass cords exceeds 6000 dtex, the carcass cords are excessively thick, and thus ride comfort deteriorates, and it is difficult to ensure run-flat durability.

Furthermore, the carcass cords (organic fiber cords) preferably have a thermal shrinkage rate of 0.5% to 2.5%, and more preferably 1.0% to 2.0%. Note that “thermal shrinkage rate” is a dry thermal shrinkage rate (%) of sample cords measured in accordance with JIS L1017 “Test methods for chemical fiber tire cords” with a length of specimen being 500 mm and when heated at 150° C. for 30 minutes. By using cords having such a thermal shrinkage rate, the occurrence of kinking (twisting, folding, wrinkling, and collapsing in shape, and the like) in the organic fiber cords during vulcanization or deterioration in uniformity can be suppressed. In this case, when the thermal shrinkage rate of the carcass cords is less than 0.5%, kinking tends to occur during vulcanization, and thus it is difficult to favorably maintain durability. When the thermal shrinkage rate of the carcass cords exceeds 2.5%, uniformity may deteriorate.

In addition, the carcass cords are configured such that a twist coefficient K represented by Formula (1) described below is preferably 2000 to 2500 and is more preferably 2100 to 2400. Note that the twist coefficient K is a value of the carcass cords after dip treatment. By using a cord having such a twist coefficient K, cord fatigue can be mitigated and excellent durability can be ensured. In this case, when the twist coefficient K of the carcass cords is less than 2000, the cord fatigue deteriorates, and thus it is difficult to ensure durability. When the twist coefficient K of the carcass cords exceeds 2500, productivity of the organic fiber cords deteriorates.

K=T×D^{1/2} (1)

(where T is an upper number of twists (twists/10 cm) of the organic fiber cords described above, and D is the total fineness (dtex) of the organic fiber cords described above).

Furthermore, the carcass cords are configured such that an elongation at break is preferably 20% or more and is more preferably 22% to 24%. Note that “elongation at break” is an elongation ratio (%) of measured sample cords measured at breaking of the cords by conducting a tensile test in accordance with JIS L1017 “Test methods for chemical fiber tire cords” with a length of specimen between grips being 250 mm and a tensile speed being 300±20 mm/minute. By using a cord having such an elongation at break, the effect of improving shock burst resistance due to the low rigidity and high fineness of the organic fiber cords can be further enhanced. In particular, shock burst resistance can be determined, for example, by a plunger energy test (a test for measuring breaking energy when the tire breaks when a plunger having a predetermined size is pressed against the central portion of the tread). However, a cord having the above-mentioned elongation at break is used, which allows for deformation during testing (when pressed against the plunger), and thus favorable results can be obtained in the plunger energy test. In this case, when the elongation at break of the carcass cords is less than 20%, favorable results cannot be obtained in the plunger energy test. In other words, the breaking energy (breaking durability of the tread portion against a projection input) when the pneumatic tire rides over protrusions on the uneven road surface cannot be increased, and the effect of improving the shock burst resistance of the pneumatic tire cannot be sufficiently expected.

The type of organic fibers constituting the carcass cords (organic fiber cords) is not particularly limited; however, for example, polyester fibers, nylon fibers, aramid fibers, or the like can be used. Out of the fibers, polyester fibers can be suitably used. Additionally, examples of the polyester fibers include polyethylene terephthalate fibers (PET fibers), polyethylene naphthalate fibers (PEN fibers), polybutylene terephthalate fibers (PBT), and polybutylene naphthalate fibers (PBN), with PET fibers being particularly suitable. Even with any fiber arbitrarily used, physical properties of each fiber advantageously provide ride comfort and steering stability under normal travel conditions in a well-balanced and highly compatible manner. In particular, in the case of PET fibers, since the PET fibers are inexpensive, the cost of the pneumatic tire can be reduced. In addition, workability in producing cords can be increased.

### EXAMPLES

Pneumatic tires of Comparative Examples 1 to 7 and Examples 1 to 4 were produced, each of the pneumatic tires has a tire size of 225/55R17 and a basic structure illustrated in FIG. 1, and the presence of a side reinforcing layer and physical properties of carcass cords that constitute a carcass layer (elongation under a 1.5 cN/dtex load, total fineness) vary from one to another as indicated in Table 1.

These test tires were evaluated for ride comfort, steering stability, shock burst resistance, and run-flat durability by the following evaluation methods. The results are indicated in Table 1.

### Ride Comfort

Each of the test tires was assembled on a wheel having a rim size of 17×7 J, inflated to an air pressure of 230 kPa, and mounted on a test vehicle (four wheel drive vehicle) having an engine displacement of 2000 cc. Sensory evaluations for ride comfort were performed on a test course of dry road surfaces by a test driver with two occupants riding in the vehicle. The evaluation results were evaluated by a 5-point method using Comparative Example 1 as 3.0 (reference) and expressed as average points of five persons excluding the highest point and the lowest point. Larger evaluation values indicate superior ride comfort. When the score is “2.5” or greater, the score means that favorable ride comfort equivalent to that of Comparative Example 1 was obtained.

### Steering Stability

Each of the test tires was assembled on a wheel having a rim size of 17'7 J, inflated to an air pressure of 230 kPa, and mounted on a test vehicle (four wheel drive vehicle) having an engine displacement of 2000 cc. Sensory evaluations for steering stability were performed on a test course of dry road surfaces by a test driver with two occupants riding in the vehicle. The evaluation results were evaluated by a 5-point method using Comparative Example 2 as 3.0 (reference) and expressed as average points of five persons excluding the highest point and the lowest point. Larger evaluation values indicate superior steering stability.

### Shock Burst Resistance

Each of the test tires was assembled on a wheel having a rim size of 17×7 J and inflated to an air pressure of 230 kPa. Tire braking tests were performed by pressing a plunger having a plunger diameter of 19±1.6 mm against the central portion of the tread at a loading speed (plunger pressing speed) of 50.0±1.5 m/min, and tire strength (tire breaking energy) was measured. The evaluation results are expressed as index values with measurement values of Comparative Example 1 being assigned the value of 100. Larger values indicate higher breaking energy and superior shock burst resistance.

### Run-Flat Durability

Each of the test tires was assembled on a wheel having a rim size of 17×7 J and allowed to run on a drum testing machine under drum durability test conditions for run-flat tires, which are described in ECE (Economic Commision for Europe) 30, and the running distance until the tire breaks was measured. The evaluation results are indicated as “Fail” when the running distance was 0 km (when run-flat traveling was not possible), as “Pass” when the running distance was less than 80 km, and as “Good” when the running distance was 80 km or longer.

TABLE 1

| | | | Comparative | Comparative | Comparative | |
|---|---|---|---|---|---|---|
| | | | Example 1 | Example 2 | Example 3 | Example 1 |
| Presence of side reinforcing layer | | | NO | NO | YES | YES |
| Carcass | Elongation under | % | 4.1 | 4.1 | 4.1 | 4.5 |
| layer | 1.5 cN/dtex load | | | | | |
| | Total fineness | dtex | 3340 | 4400 | 4400 | 4400 |
| | Thermal shrinkage rate | % | 2.0 | 1.9 | 2.0 | 1.8 |
| | Twist coefficient K | | 2200 | 2200 | 2200 | 2200 |
| | Elongation at break | % | 18 | 18 | 18 | 21 |

| | | | | | |
|---|---|---|---|---|---|
| Ride comfort | | 3.0 | 2.8 | 2.3 | 2.7 |
| Steering stability | | 2.8 | 3.0 | 3.5 | 3.2 |
| Shock burst resistance | Index | 100 | 102 | 98 | 100 |
| | value | | | | |
| Run-flat durability | | Fail | Fail | Good | Good |

| | | | | Comparative | Comparative | Comparative |
|---|---|---|---|---|---|---|
| | | | Example 2 | Example 4 | Example 5 | Example 6 |
| Presence of side reinforcing layer | | | YES | YES | NO | YES |
| Carcass | Elongation under | % | 5.8 | 6.2 | 4.5 | 5.2 |
| layer | 1.5 cN/dtex load | | | | | |
| | Total fineness | dtex | 4400 | 4400 | 4400 | 3340 |
| | Thermal shrinkage rate | % | 1.6 | 1.5 | 1.8 | 1.6 |
| | Twist coefficient K | | 2200 | 2200 | 2200 | 2200 |
| | Elongation at break | % | 24 | 26 | 21 | 23 |

| | | | | | |
|---|---|---|---|---|---|
| Ride comfort | | 3.0 | 2.8 | 3.0 | 2.9 |
| Steering stability | | 3.0 | 2.8 | 2.8 | 2.9 |
| Shock burst resistance | Index | 103 | 104 | 104 | 100 |
| | value | | | | |
| Run-flat durability | | Good | Pass | Fail | Good |

| | | | | | Comparative |
|---|---|---|---|---|---|
| | | | Example 3 | Example 4 | Example 7 |
| Presence of side reinforcing layer | | | YES | YES | YES |
| Carcass | Elongation under | % | 5.2 | 5.2 | 5.2 |
| layer | 1.5 cN/dtex load | | | | |
| | Total fineness | dtex | 4400 | 5520 | 6600 |
| | Thermal shrinkage rate | % | 1.7 | 1.6 | 1.7 |
| | Twist coefficient K | | 2200 | 2200 | 2200 |
| | Elongation at break | % | 23 | 23 | 23 |

| | | | | |
|---|---|---|---|---|
| Ride comfort | | 2.8 | 2.6 | 2.4 |
| Steering stability | | 3.1 | 3.4 | 3.5 |
| Shock burst resistance | Index | 102 | 103 | 104 |
| | value | | | |
| Run-flat durability | | Good | Good | Pass |

As can be seen from Table 1, Comparative Examples 1, 2 did not include the side reinforcing layer, run-flat traveling was unable to be performed. In addition, when Comparative Example 1 and Comparative Example 2 were compared, Comparative Example 1 in which the total fineness of the carcass cords is low had low steering stability, and Comparative Example 2 in which the total fineness of the carcass cords was high tended to have low ride comfort. In contrast, in any of Examples 1 to 4, run-flat durability was ensured by the side reinforcing layers, and in the meantime, favorable ride comfort equal to that of the tire (Comparative Examples 1, 2) not including the side reinforcing layers was ensured. In addition, steering stability was improved equally to or more than Comparative Example 2, and further shock burst resistance equal to or greater than that of Comparative Examples 1, 2 was ensured.

In Comparative Example 3, since elongation of the carcass cords under a 1.5 cN/dtex load was small, ride comfort and shock burst resistance were deteriorated. In Comparative Example 4, since elongation of the carcass cords under a 1.5 cN/dtex load was large, steering stability was deteriorated and sufficient run-flat durability was not obtained. In Comparative Example 5, identical carcass cords as in Example 1 were used; however, since the tire did not include the side reinforcing layers, run-flat traveling was unable to be performed, and steering stability was deteriorated. In Comparative Example 6, since the total fineness of the carcass cords was low, steering stability was deteriorated. In Comparative Example 7, since the total fineness of the carcass cords was high, ride comfort was deteriorated and sufficient run-flat durability was not obtained.

1. A pneumatic tire comprising:
a tread portion extending in a tire circumferential direction and having an annular shape;
a pair of sidewall portions respectively disposed on both sides of the tread portion;
a pair of bead portions each disposed on an inner side of the sidewall portion in a tire radial direction;
a carcass layer mounted between the pair of bead portions; and
side reinforcing layers each provided on an inner side in a tire width direction of the carcass layer in the sidewall portion and having a crescent-shaped cross-section,
carcass cords that constitute the carcass layer having an elongation of 4.3% to 6.0% under a 1.5 cN/dtex load, the carcass cords being organic fiber cords having a total fineness of 4000 dtex to 6000 dtex.

2. The pneumatic tire according to claim 1, wherein a thermal shrinkage rate of the organic fiber cords is 0.5% to 2.5%.

3. The pneumatic tire according to claim 1, wherein a twist coefficient K expressed in following Formula (1) of the organic fiber cords is 2000 to 2500
K=T×D^{1/2} (1)
(where T is an upper number of twists (twists/10 cm) of the organic fiber cords described above, and D is a total fineness (dtex) of the organic fiber cords described above).

4. The pneumatic tire according to claim 1, wherein an elongation at break of the organic fiber cords is 20% or more.

5. The pneumatic tire according to claim 1, wherein the organic fiber cords are formed of polyethylene terephthalate fibers.

6. The pneumatic tire according to claim 2, wherein a twist coefficient K expressed in following Formula (1) of the organic fiber cords is 2000 to 2500
K=T×D^{1/2} (1)
(where T is an upper number of twists (twists/10 cm) of the organic fiber cords described above, and D is a total fineness (dtex) of the organic fiber cords described above).

7. The pneumatic tire according to claim 6, wherein an elongation at break of the organic fiber cords is 20% or more.

8. The pneumatic tire according to claim 7, wherein the organic fiber cords are formed of polyethylene terephthalate fibers.
